(19) United States
(12) Patent Application Publication
(10) Pub. No.: US 2017/0302998 A1
(43) Pub. Date: Oct. 19, 2017

(54) INFORMATION PROCESSING APPARATUS AND INFORMATION PROCESSING METHOD

(71) Applicant: Sony Corporation, Tokyo (JP)

(72) Inventors: Hideo Nagasaka, Kanagawa (JP); Shunji Yoshimura, Tokyo (JP)

(73) Assignee: Sony Corporation, Tokyo (JP)

(21) Appl. No.: 15/512,913

(22) PCT Filed: Aug. 11, 2015
(86) PCT No.: PCT/JP2015/072737

§ 371 Date: Mar. 21, 2017

(30) Foreign Application Priority Data
Sep. 29, 2014 (JP) 2014-198976

(51) Int. Cl. H04N 21/442; H04N 21/4788; H04N 21/4722; H04N 21/235; H04N 21/45; H04N 21/81; H04L 29/08; H04L 29/06

(52) U.S. Cl. CPC H04N 21/44222; H04N 21/8133; H04N 21/4788; H04N 21/4722; H04L 67/22; H04N 21/44213; H04N 21/2353; H04N 21/4524; H04L 67/42

(57) ABSTRACT

[Object] To provide a technology for understanding the situation of a user who has written the written data with higher accuracy.

[Solution] Provided is an information processing apparatus including: a data determination unit configured to determine whether or not related information of a predetermined incident is included in written data by a user; a time determination unit configured to determine whether or not a registration time of the written data belongs to a predetermined duration period including a period during which the predetermined incident is occurring; and a data processing unit configured to attach an indication that the user is involved in the predetermined incident to the written data, when the related information of the predetermined incident is included in the written data and the registration time of the written data belongs to the duration period.

### TECHNICAL FIELD

The present disclosure relates to an information processing apparatus and an information processing method.

### BACKGROUND ART

In recent years, information processing systems are widespread which, when data written by one user (hereinafter simply referred to as “written data”) is registered in a server, allow another user to view the written data registered in the server in response to a request from the other user.

For example, a technology is disclosed in which a hashtag indicating a broadcast station of a program received by a television receiver is given to the written data at the time of registration of the written data, in order to make identifiable the program that the written data is registered for in the server (see, for example, Patent Literature 1).

### CITATION LIST

### Patent Literature

Patent Literature 1: JP 2012-109795A

### DISCLOSURE OF INVENTION

### Technical Problem

However, it is desirable to provide a technology for understanding the situation of a user who has written the written data with higher accuracy.

### Solution to Problem

According to the present disclosure, there is provided an information processing apparatus including: a data determination unit configured to determine whether or not related information of a predetermined incident is included in written data by a user; a time determination unit configured to determine whether or not a registration time of the written data belongs to a predetermined duration period including a period during which the predetermined incident is occurring; and a data processing unit configured to attach an indication that the user is involved in the predetermined incident to the written data, when the related information of the predetermined incident is included in the written data and the registration time of the written data belongs to the duration period.

According to the present disclosure, there is provided an information processing method including: determining whether or not related information of a predetermined incident is included in written data by a user; determining whether or not a registration time of the written data belongs to a predetermined duration period including a period during which the predetermined incident is occurring; and attaching an indication that the user is involved in the predetermined incident to the written data, when the related information of the predetermined incident is included in the written data and the registration time of the written data belongs to the duration period.

### Advantageous Effects of Invention

As described above, the present disclosure provides a technology for understanding the situation of the user who has written the written data with higher accuracy. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a configuration example of an information processing system according to a first embodiment of the present disclosure.

FIG. 2 is a block diagram illustrating a functional configuration example of an information processing apparatus according to the same embodiment.

FIG. 3 is a diagram illustrating an example of a written data display screen image.

FIG. 4 is a diagram illustrating a display example of detailed information of a program.

FIG. 5 is a diagram illustrating an example of a display screen image of a program received by an activated program reception function.

FIG. 6 is a flowchart illustrating an operation example of estimation of users who are viewing programs.

FIG. 7 is a diagram illustrating an example of a user presentation screen image for presenting users who are viewing programs for the respective programs.

FIG. 8 is a flowchart illustrating a flow of operation for presenting users who are viewing programs for the respective programs.

FIG. 9 is a diagram illustrating an example of a display screen image for presenting other users who are viewing programs for the respective programs.

FIG. 10 is a diagram illustrating an example of a display screen image for informing of other users who have viewed the same program as one user on the basis of a view history.

FIG. 11 is a diagram illustrating a configuration example of an information processing system according to a second embodiment of the present disclosure.

FIG. 12 is a block diagram illustrating a functional configuration example of an information processing apparatus according to the same embodiment.

FIG. 13 is a diagram illustrating an example of a written data display screen image.

FIG. 14 is a diagram illustrating a display example of detailed information of an event.

FIG. 15 is a diagram illustrating a display example of detailed information of an event.

FIG. 16 is a flowchart illustrating an operation example of estimation of users who are participating in events.

FIG. 17 is a diagram illustrating an example of a display screen image for presenting other users who are participating in events for the respective events.

FIG. 18 is a flowchart illustrating a flow of operation for presenting users who are participating in events for the respective events.

FIG. 19 is a block diagram illustrating a hardware configuration example of an information processing apparatus.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that, in this description and the drawings, structural elements that have substantially the same function and structure are sometimes distinguished from each other using different alphabets after the same reference sign. However, when there is no need in particular to distinguish structural elements that have substantially the same function and structure, the same reference sign alone is attached.

Description will be made in the following order.

0. Overview

### 1. First Embodiment

### 1.1. System Configuration Example

### 1.2. Functional Configuration Example

### 1.3. Estimation of Users Who are Watching Programs

### 1.4. Example of Presenting Users Who are Watching Programs for Respective Programs

### 2. Second Embodiment

### 2.1. System Configuration Example

### 2.2. Functional Configuration Example

### 2.3. Estimation of Users Who are Participating in Events

### 2.4. Example of Presenting Users Who are Participating in Events for Respective Events

### 3. Hardware Configuration Example

### 4. Conclusion

### 0. Overview

In recent years, information processing systems are widespread which, when written data is registered in a server, allow another user to view the written data registered in the server in response to a request from the other user. For example, a technology is disclosed in which a hashtag indicating a broadcast station of a program received by a television receiver is given to the written data at the time of registration of the written data, in order to make identifiable the program that the written data is registered for in the server.

However, even if the program is received by the television receiver at the time of registration of the written data, there is a possibility that the program is not actually viewed by the user. Therefore, it is desired to provide a technology for understanding the situation of the user who has written the written data (more specifically, whether or not the user who has written the written data is involved in a predetermined incident) with higher accuracy. Therefore, in the present specification, such a technology will be described in detail.

Specifically, an information processing apparatus according to an embodiment of the present disclosure includes a data determination unit that determines whether or not related information of the predetermined incident is included in written data by the user, and a time determination unit that determines whether or not a registration time of the written data belongs to a predetermined duration period including a period during which the predetermined incident is occurring. Further, the information processing apparatus includes a data processing unit that attaches to the written data an indication that the user is involved in the predetermined incident, when the related information of the predetermined incident is included in the written data and the registration time of the written data belongs to the duration period.

According to this configuration, it is possible to understand the situation of the user who has written the written data with higher accuracy. Here, the duration period is not limited particularly. For example, the duration period may include a time from a start time of the predetermined incident or a predetermined time before the start of the predetermined incident to an end time of the predetermined incident or a predetermined time after the end of the predetermined incident. In each of the following embodiments, a case in which the duration period is the period from the start time of the predetermined incident to the end time of the predetermined incident will be described as an example.

### 1. First Embodiment

First, a first embodiment of the present disclosure will be described. The first embodiment of the present disclosure describes, as an example, a case in which the above “predetermined incident” is “broadcasting of content (hereinafter also referred to as “program”) from a broadcast station”, and the above “involvement in a predetermined incident by a user” is “viewing of a program”, and the above “indication that the user is involved in the predetermined incident” is “indication that the user is watching the program”. Also, in the first embodiment of the present disclosure, a case in which the above “related information of the predetermined incident” is “information related to broadcasting of the program” will be described as an example.

### 1.1. System Configuration Example

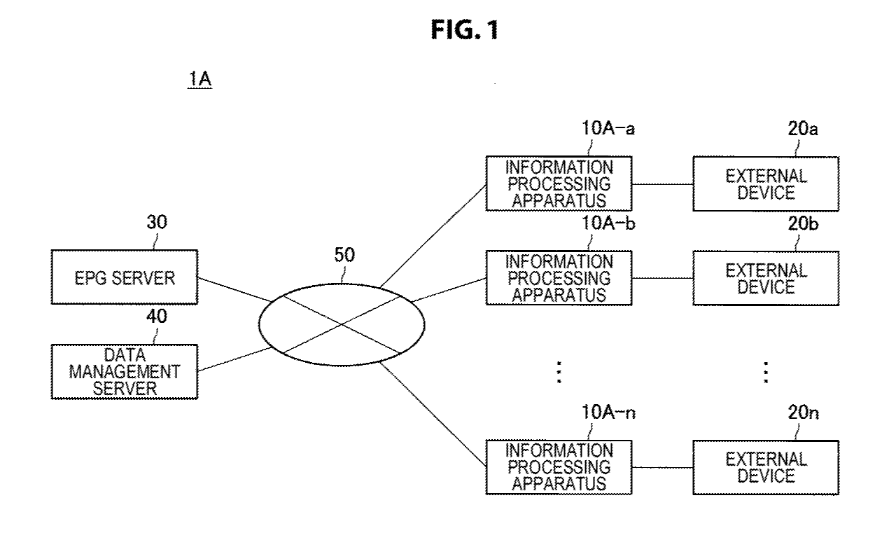

First, a configuration example of an information processing system 1A according to the first embodiment of the present disclosure will be described with reference to drawings. FIG. 1 is a diagram illustrating a configuration example of the information processing system 1A according to the first embodiment of the present disclosure. As illustrated in FIG. 1, the information processing system 1A according to the first embodiment of the present disclosure includes information processing apparatuses 10A-a to 10A-n, external devices 20a to 20n, an electronic program guide (EPG) server 30, and a data management server 40. The information processing apparatuses 10A-a to 10A-n, the EPG server 30, and the data management server 40 are connected to a network 50. Also, the external devices 20a to 20n are connected to the information processing apparatuses 10A-a to 10A-n, respectively.

The EPG server 30 transmits information (hereinafter also referred to as “program information”) related to broadcasting of the programs supplied to the television receiver, to the information processing apparatuses 10A-a to 10A-n via the network 50. Although the specific structure of the program information is not limited particularly, the program information may include at least one of the names of cast members in the program, the name of the broadcast station that broadcasts the program, the name of the program, the hashtag of the broadcast station that broadcasts the program, the hashtag of the program, and detailed information of the program, for example. In the following, a case in which the program information includes all of the names of cast members in the program, the name of the broadcast station that broadcasts the program, the name of the program, the hashtag of the broadcast station that broadcasts the program, the hashtag of the program, and the detailed information of the program will be described as an example. Also, the EPG server 30 transmits the broadcast period of the program (start time and end time of the program) to the information processing apparatuses 10A-a to 10A-n via the network 50. Note that, in the following, an example in which the program information supplied from the EPG server 30 is used will be described mainly, but program information extracted from the written data stored by the data management server 40 may be used.

The information processing apparatuses 10A-a to 10A-n are used by respective users. In the following, the users using the information processing apparatuses 10A-a to 10A-n will be referred to as a user AAA to a user NNN, but the numbers of information processing apparatuses 10A and users are each not limited particularly. The information processing apparatus 10A is capable of receiving the program information from the EPG server 30. Also, the information processing apparatus 10A attempts to log in to the data management server 40 on the basis of user identification information and a password input by the user, for example. Although in the following a case in which the name of the user is used as the user identification information will be described as an example, the user identification information is not limited to the name of the user but may be an account uniquely assigned to the user.

When the login is completed and a request to view the written data is input from the user, the information processing apparatus 10A receives the written data from the data management server 40 via the network 50 and displays the written data. At this time, the written data received from the data management server 40 may be written data (time line data) that the user is following. On the other hand, when the written data is input by the user, the information processing apparatus 10A transmits the input written data to the data management server 40 via the network 50.

The external device 20 activates a predetermined function (for example, a function as a television receiver, etc.) in response to an activation signal from the information processing apparatus 10A to be connected. The predetermined function activated by the information processing apparatus 10A will be described later. Although in the example illustrated in FIG. 1 the information processing system 1 A includes the external devices 20a to 20n, the information processing system 1A is needless to include the external devices 20a to 20n when the information processing apparatuses 10A-a to 10A-n themselves have the predetermined function.

When receiving the written data from the information processing apparatus 10A, the data management server 40 can store the received written data. At this time, the data management server 40 can store the reception time of the written data as the registration time of the written data in association with the written data. Furthermore, the data management server 40 can store the account of the user of the information processing apparatus 10A that has transmitted the written data in association with the written data.

The configuration example of the information processing system 1A according to the first embodiment of the present disclosure has been described above.

### 1.2. Functional Configuration Example

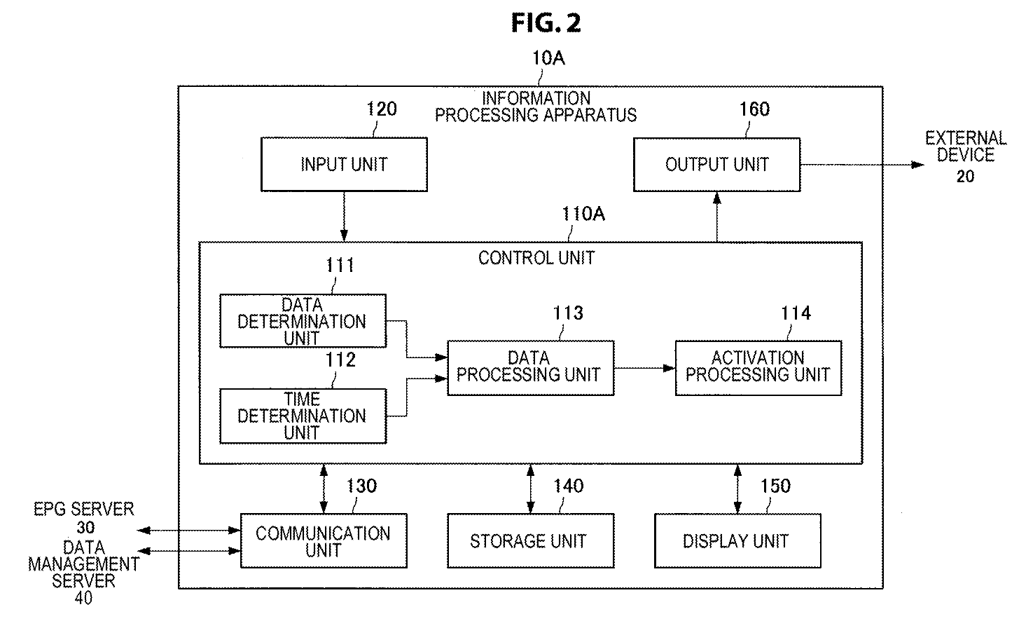

Next, a functional configuration example of the information processing apparatus 10A according to the first embodiment of the present disclosure will be described. FIG. 2 is a block diagram illustrating a functional configuration example of the information processing apparatus 10A according to the first embodiment of the present disclosure. As illustrated in FIG. 2, the information processing apparatus 10A according to the first embodiment of the present disclosure includes a control unit 110A, an input unit 120, a communication unit 130, a storage unit 140, a display unit 150, and an output unit 160.

The control unit 110A can be equivalent to a processor such as a central processing unit (CPU), for example. When the control unit 110A is equivalent to a processor such as a CPU, such a processor can be configured with an electronic circuit. The control unit 110A performs various functions of the control unit 110A by executing a program stored in the storage unit 140 or other storage media. The control unit 110A includes a data determination unit 111, a time determination unit 112, a data processing unit 113, and an activation processing unit 114. Functions of the data determination unit 111, the time determination unit 112, the data processing unit 113, and the activation processing unit 114 will be described later.

The input unit 120 accepts operation by the user and outputs the accepted operation to the control unit 110A. In this specification, since it is assumed that the input unit 120 is configured with a touch panel, the operation by the user is input with a finger of the user as an operation body. However, the input unit 120 may be configured with hardware other than the touch panel. In the example illustrated in FIG. 2, the input unit 120 is integrated with the information processing apparatus 10A, but the input unit 120 may be configured separately from the information processing apparatus 10A.

The communication unit 130 can communicate with another device (for example, the EPG server 30, the data management server 40, etc.) via the network 50. The type of communication by the communication unit 130 is not limited particularly, and the communication by the communication unit 130 may be wireless communication or wired communication. In the example illustrated in FIG. 2, the communication unit 130 is integrated with the information processing apparatus 10A, but the communication unit 130 may be configured separately from the information processing apparatus 10A.

The storage unit 140 stores a program for operating the control unit 110A, by using a storage medium such as a semiconductor memory or a hard disk. Also, for example, the storage unit 140 can store various types of data (for example, various types of setting information, content, etc.) used by the program. In the example illustrated in FIG. 2, the storage unit 140 is integrated with the information processing apparatus 10A, but the storage unit 140 may be configured separately from the information processing apparatus 10A.

The display unit 150 displays various types of information in accordance with the control of the control unit 110A. The display unit 150 is configured with a liquid crystal display (LCD), an organic electroluminescence (EL) display device, or the like, for example. In the example illustrated in FIG. 2, the display unit 150 is integrated with the information processing apparatus 10A, but the display unit 150 may be configured separately from the information processing apparatus 10A.

The output unit 160 is capable of outputting a control signal generated by the control unit 110A to the external device 20. For example, the output unit 160 can output an activation signal generated by the control unit 110A to the external device 20. Here, the activation signal can be equivalent to a signal for activating a predetermined function (for example, a function as a television receiver) by the external device 20.

The functional configuration example of the information processing apparatus 10A according to the first embodiment of the present disclosure has been described above.

### 1.3. Estimation by Users Who are Viewing Programs

Next, an example of the function of the information processing apparatus 10A according to the first embodiment of the present disclosure will be described. As described above, the information processing apparatus 10A attempts to log in to the data management server 40 on the basis of the user identification information and the password input by the user. When login is completed and a request for viewing the written data is input from the user, the communication unit 130 of the information processing apparatus 10A receives the written data from the data management server 40 via the network 50, and the data processing unit 113 causes the display unit 150 to display the written data received by the communication unit 130.

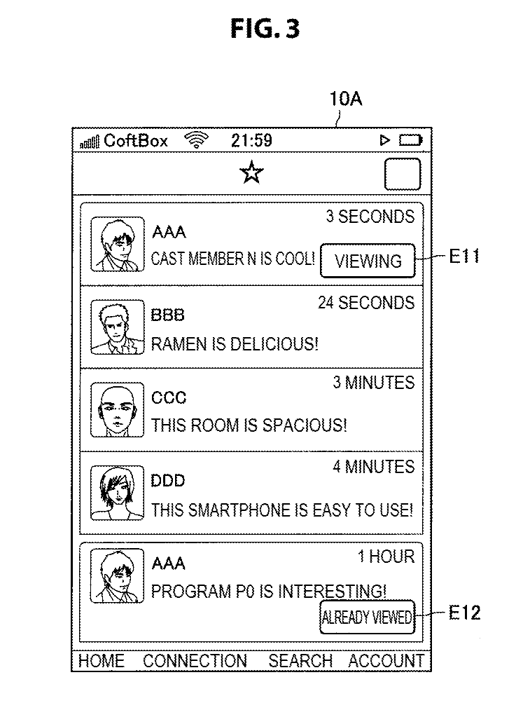

FIG. 3 is a diagram illustrating an example of a written data display screen image. FIG. 3 illustrates an example in which the data processing unit 113 of the information processing apparatus 10A causes the display unit 150 to display the written data “cast member N is cool!” whose (user's name, difference period between current time and registration time) are (AAA, 3 seconds). In the same way, in the example illustrated in FIG. 3, the data processing unit 113 of the information processing apparatus 10A causes the display unit 150 to display the written data “ramen is delicious!” whose (user's name, difference period between current time and registration time) are (BBB, 24 seconds).

Also, the data processing unit 113 of the information processing apparatus 10A causes the display unit 150 to display the written data “this room is spacious!” whose (user's name, difference period between current time and registration time) are (CCC, 3 minutes). Also, the data processing unit 113 of the information processing apparatus 10A causes the display unit 150 to display the written data “this smartphone is easy to use!” whose (user's name, difference period between current time and registration time) are (DDD, 4 minutes). Further, the data processing unit 113 of the information processing apparatus 10A causes the display unit 150 to display the written data “program P0 is interesting!” whose (user's name, difference period between current time and registration time) are (AAA, 1 hour).

Here, the data determination unit 111 determines whether or not program information is included in the written data by the user, and the time determination unit 112 determines whether or not the registration time of the written data belongs to the broadcast period of the program. When the program information is included in the written data and the registration time of the written data belongs to the broadcast period of the program, the data processing unit 113 estimates that the user is viewing the program, and attaches an indication that the user is viewing the program to the written data.

For example, it is assumed that the data determination unit 111 has determined that the written data “cast member N is cool!” by the user AAA includes a cast member name “cast member N”. Also, it is assumed that the time determination unit 112 has determined that the registration time of the written data “cast member N is cool!” belongs to the broadcast period of this program. In that case, the data processing unit 113 may attach a button E11 (hereinafter also simply referred to as “viewing button E11”) in which a character string “viewing” is written, to the written data “cast member N is cool!”.

According to this configuration, both the viewpoint as to whether or not the registration time of the written data is included in the broadcast period of the program and the viewpoint as to whether or not the program information is included in the written data are used to determine the viewing situation of the program. Therefore, it is possible to understand the situation of the user who has written the written data with higher accuracy. Note that, instead of the viewing button E11, some object indicating that the user is viewing the program may be attached to the written data “cast member N is cool!”.

Also, the data processing unit 113 may permanently attach the viewing button E11 to the written data, but if a predetermined condition is satisfied, the data processing unit 113 may attach an indication that the user no longer views the program, to the written data. According to this configuration, it is possible to understand the situation of the user who has written the written data with higher accuracy, by further considering the possibility that the user no longer views the program.

For example, even if the viewing button E11 is once attached to one written data, the data processing unit 113 may attach an indication that the user no longer views the program, to the one written data, when there is another written data by the same user including information related to the broadcast of another program that is to be broadcast later than the broadcast of the program (another program whose broadcast start is later than the broadcast end of one program).

In the example illustrated in FIG. 3, the written data “program P0 is interesting!” written by the user AAA includes the program name (program P0). However, the written data “cast member N is cool!” written by the same user AAA includes a cast member name (cast member N) of another program that is to be broadcast after the broadcast of the program. Therefore, the data processing unit 113 may attach a button E12 in which a character string “already viewed” is written (hereinafter also simply referred to as “already-viewed button E12”) to the written data “program P0 is interesting!”, to the written data “cast member N is cool!”.

According to this configuration, it is possible to understand the situation of the user who has written the written data with higher accuracy, by considering the possibility that the user no longer views the one program as a result of the user starting viewing the other program. Note that, instead of the already-viewed button E12, some object indicating that the user no longer views the program may be attached to the written data “program P is interesting!”.

Further, for example, even if the viewing button E11 is once attached to one written data, the data processing unit 113 may attach an indication that the user no longer views the program to the written data when the current time no longer belongs to the broadcast period of the program that was being viewed. According to this configuration, it is possible to understand the situation of the user who has written the written data with higher accuracy, by considering the possibility that the user can no longer view the program due to the end of the broadcast period of the program.

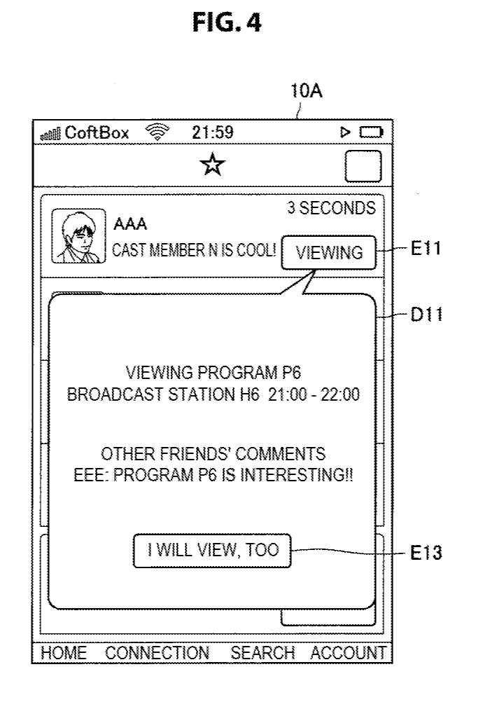

The viewing button E11 displayed in this way may be selectable by the user who operates the information processing apparatus 10A. The data processing unit 113 may cause the display unit 150 to display detailed information of the program being viewed, when the user who operates the information processing apparatus 10A selects the viewing button E11. FIG. 4 is a diagram illustrating a display example of the detailed information of the program. FIG. 4 illustrates an example in which the data processing unit 113 displays the detailed information D11 of the program P6 that the user AAA is viewing, when the user who operates the information processing apparatus 10A selects the viewing button E11 attached to the written data “cast member N is cool!”.

Although the detailed information D11 includes “viewing program P6”, “broadcast station H6”, “21:00-22:00” and the like, the name of the program, the name of the broadcast station that broadcasts the program, and the broadcast period of the program can be acquired from the EPG server 30. Also, the detailed information D11 may include written data by users other than the user AAA which includes the information related to the broadcast of the program P6 (for example, written data “program P6 is interesting!” by the user EEE which includes “program P6” which is the name of the program P6) as “other friends' comments”.

Also, it may be such that the user of the information processing apparatus 10A can view the program P6 that the user AAA is viewing, by selection of a program view button E13 (or the viewing button E11) indicating the will to view the program. In other words, when the program view button E13 (or the viewing button E11) is selected by the user who operates the information processing apparatus 10A, the activation processing unit 114 may activate a reception function of the program P6 by the external device 20 connected to the information processing apparatus 10A. The external device 20 may display a display screen image of the program P6 received by the activated reception function.

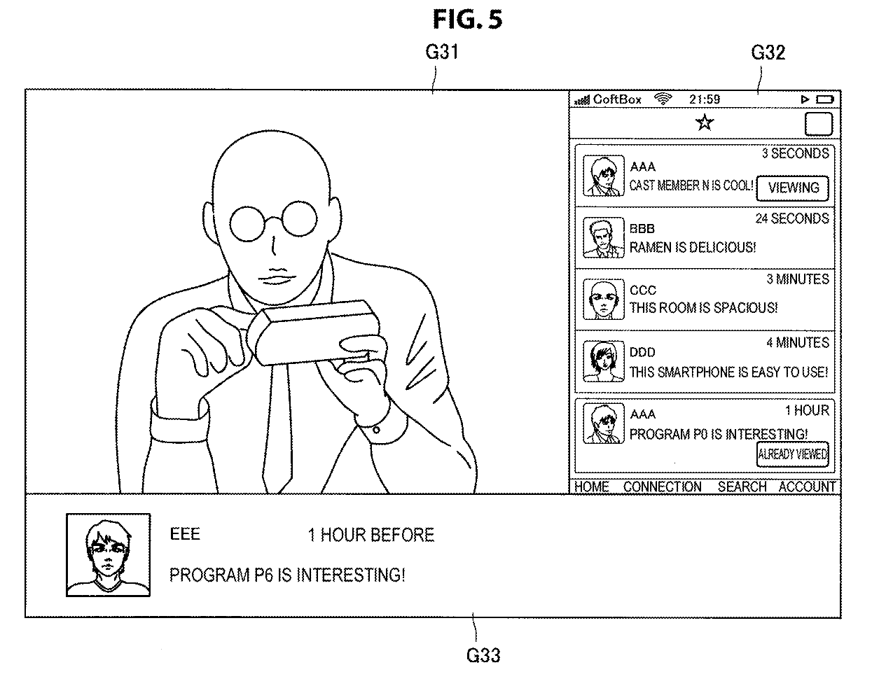

FIG. 5 is a diagram illustrating an example of the display screen image of the program P6. The program display screen image illustrated in FIG. 5 includes a program display window G31, a written data display window G32, and a written data display window G33. For example, the program display window G31 may display the program P6 received by activation of the program reception function activated by the activation processing unit 114. Also, for example, the written data display window G32 may display written data (time line data) that the user is following. Also, for example, the written data display window G33 may display written data including information related to the broadcast of the program P6 received by the activated reception function. Note that the hashtag of the program or the hashtag of the broadcast station that broadcasts the program may be automatically inserted in the written data by the user of the information processing apparatus 10A, since the program view button E13 (or the viewing button E11) is selected (until the end of the broadcast of the program).

Although an example in which the external device 20 has the program reception function activated by the activation processing unit 114 has been described in the above, the information processing apparatus 10 may have the program reception function activated by the activation processing unit 114. In that case, the program received by the program reception function of the information processing apparatus 10A may be displayed on the display unit 150 of the information processing apparatus 10A. Alternatively, stream of the program received by the program reception function of the information processing apparatus 10A may be distributed from the information processing apparatus 10A to the external device 20, and the stream may be displayed by the external device 20.

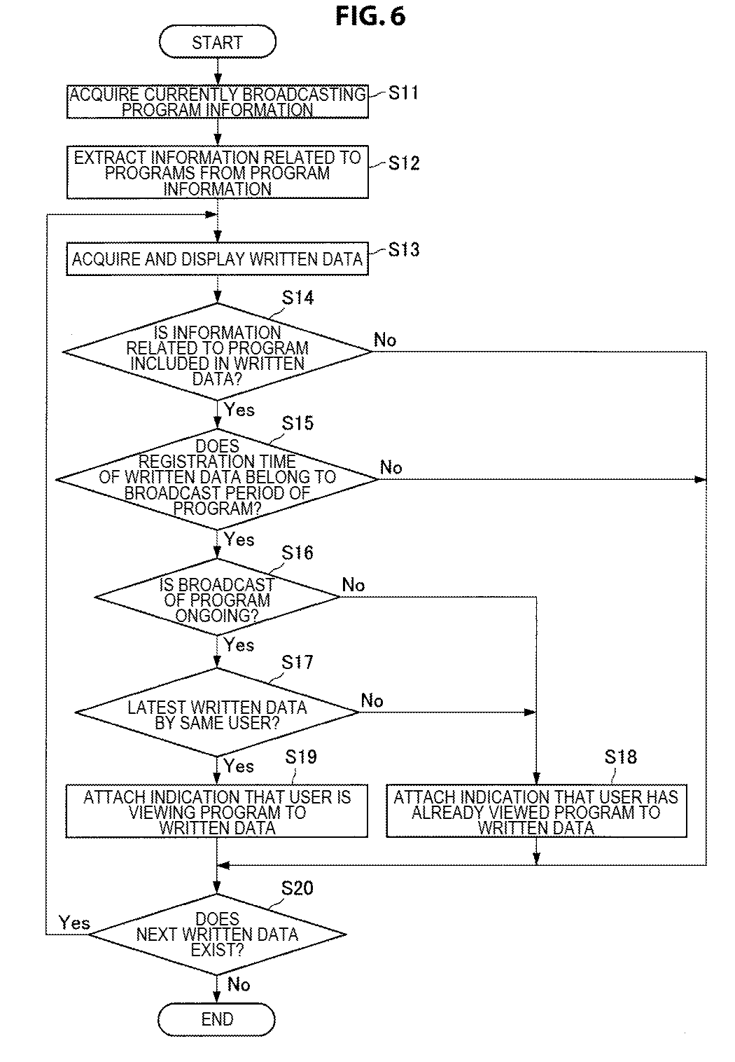

Next, an operation example of estimation of users who are viewing programs, which is an example of a function of the information processing apparatus 10A according to the first embodiment of the present disclosure, will be described. FIG. 6 is a flowchart illustrating an operation example of estimation of users who are viewing programs, which is an example of a function of the information processing apparatus 10A according to the first embodiment of the present disclosure. The operation example illustrated in FIG. 6 is merely an example of estimation operation of users who are viewing programs. Therefore, the estimation operation of users who are viewing programs is not limited to the operation example illustrated in FIG. 6.

First, the control unit 110A of the information processing apparatus 10A acquires the program information received by the communication unit 130 from the EPG server 30 via the network 50 (S11). Subsequently, the control unit 110A extracts information related to the broadcast of the programs from the acquired program information (S12). Subsequently, the data processing unit 113 acquires the written data received by the communication unit 130 from the data management server 40 via the network 50, and causes the display unit 150 to display the acquired written data (S13).

Subsequently, the data determination unit 111 determines whether or not information related to the program is included in the written data (S14). At this time, if it is determined that the information related to the program is not included in the written data (“No” in S14), the control unit 110A proceeds to the operation of S20. On the other hand, if it is determined that the information related to the program is included in the written data (“Yes” in S14), the time determination unit 112 determines whether or not the registration time of the written data belongs to the broadcast period of the program (S15). At this time, if it is determined that the registration time of the written data does not belong to the broadcast period of the program (“No” in S15), the control unit 110A proceeds to the operation of S20.

Subsequently, the data processing unit 113 determines whether or not the program broadcasting is ongoing, with reference to the broadcast period of the program and current time (S16). If the data processing unit 113 determines that the program broadcasting is not ongoing (“No” in S16), the data processing unit 113 proceeds to the operation of S18. On the other hand, if the data processing unit 113 determines that the program broadcasting is ongoing (“Yes” in S16), the data processing unit 113 determines whether or not the written data is the latest written data by the same user (S17). Although such determination may be made in any way, this determination may be made by acquiring the written data in order from newer registration time and checking whether or not the acquired written data is the first written data by the same user, for example.

If the data processing unit 113 determines that the written data is not the latest written data by the same user (“No” in S17), the data processing unit 113 proceeds to the operation of S18. On the other hand, if the data processing unit 113 determines that the written data is the latest written data by the same user (“Yes” in S17), the data processing unit 113 proceeds to the operation of S19. Subsequently, when the operation has proceeded to S18, the data processing unit 113 attaches an indication that the user has already viewed the program to the written data (S18), and proceeds to the operation of S20. On the other hand, when the operation has proceeded to S19, the data processing unit 113 attaches an indication that the user is viewing the program to the written data (S19), and proceeds to the operation of S20.

When the operation has proceeded to S20, the control unit 110A determines whether or not the next written data exists (S20). If it is determined that the next written data exists (“Yes” in S20), the control unit 110A proceeds to the operation of S13. On the other hand, if it is determined that the next written data does not exist (“No” in S20), the control unit 110A may end the operation.

In the above, the estimation of the users who are viewing the programs, which is an example of the function of the information processing apparatus 10A according to the first embodiment of the present disclosure, has been described.

### 1.4. Example of Presenting Users Who are Viewing Programs for Respective Programs

Next, an example of presenting the users who are viewing the programs for the respective programs, which is an example of the function of the information processing apparatus 10A according to the first embodiment of the present disclosure, will be described. In the above, an example is described in which the indication that the program is being viewed is attached to the written data of the user, when the user estimated to be viewing the program exists. However, the method of how to present the users estimated to be viewing the programs is not limited to the above. For example, the data processing unit 113 may present one or a plurality of users (for example, names of the users) for the respective programs being viewed. According to this configuration, it is possible to understand the users who are viewing the programs on a program-by-program basis.

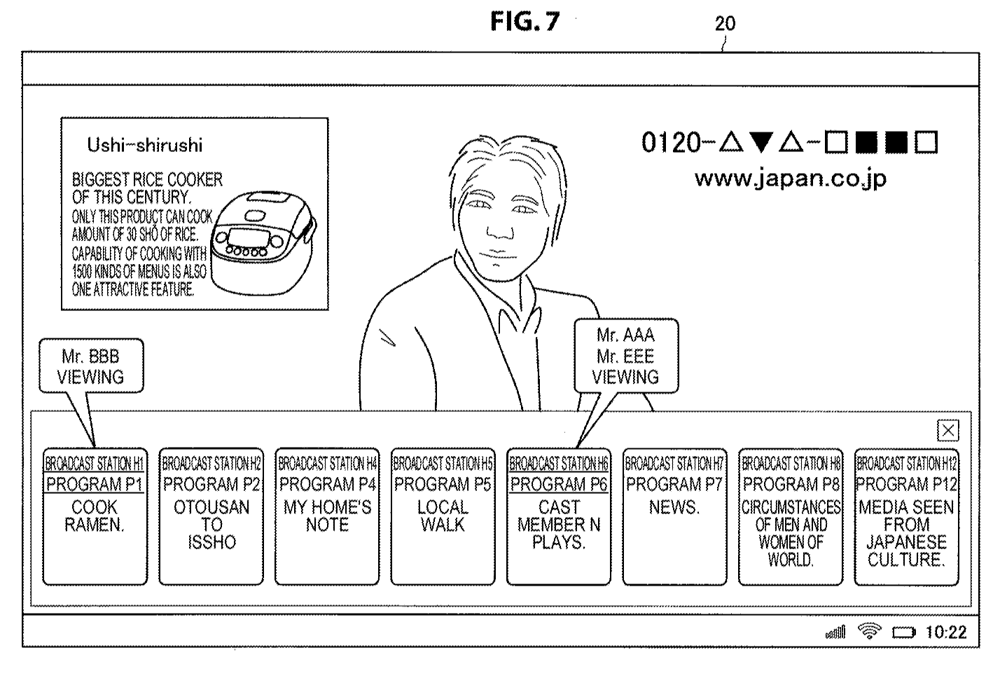

FIG. 7 is a diagram illustrating an example of a user presentation screen image for presenting the users who are viewing the programs for the respective programs. With reference to FIG. 7, the user presentation screen image includes (broadcast station H1, program P1, cook ramen.) (broadcast station H2, program P2, together with dad.) (broadcast station H4, program P4, my home's note), (broadcast station H5, program P5, local walk), (broadcast station H6, program P6, cast member N plays.) (broadcast station H7, program P7, news.), (broadcast station H8, program P8, circumstances of men and women of the world.), (broadcast station H12, program P12, media seen from Japanese culture.) as (the name of the broadcast station that broadcasts a program, the name of the program, detailed information of the program).

Although FIG. 7 illustrates an example in which this user presentation screen image is displayed by the external device 20, the user presentation screen image may be displayed on the display unit 150 of the information processing apparatus 10A. When the user presentation screen image is displayed by the external device 20, the name of the broadcast station that broadcasts the program, the name of the program, and the detailed information of the program may be directly acquired from the EPG server 30 by the external device 20, or may be supplied from the EPG server 30 to the external device 20 via the information processing apparatus 10A.

Here, the data processing unit 113 may present the user AAA, the user BBB, and the user EEE for the respective programs being viewed. That is, when estimating that the user BBB is viewing the program P1 and estimating that the user AAA and the user EEE are viewing the program P6, the data processing unit 113 may associate the user BBB with the program P1 and associate the user AAA and the user EEE with the program P6, as illustrated in FIG. 7. When displayed in this manner, it becomes possible to understand the users who are viewing the programs on a program-by-program basis.

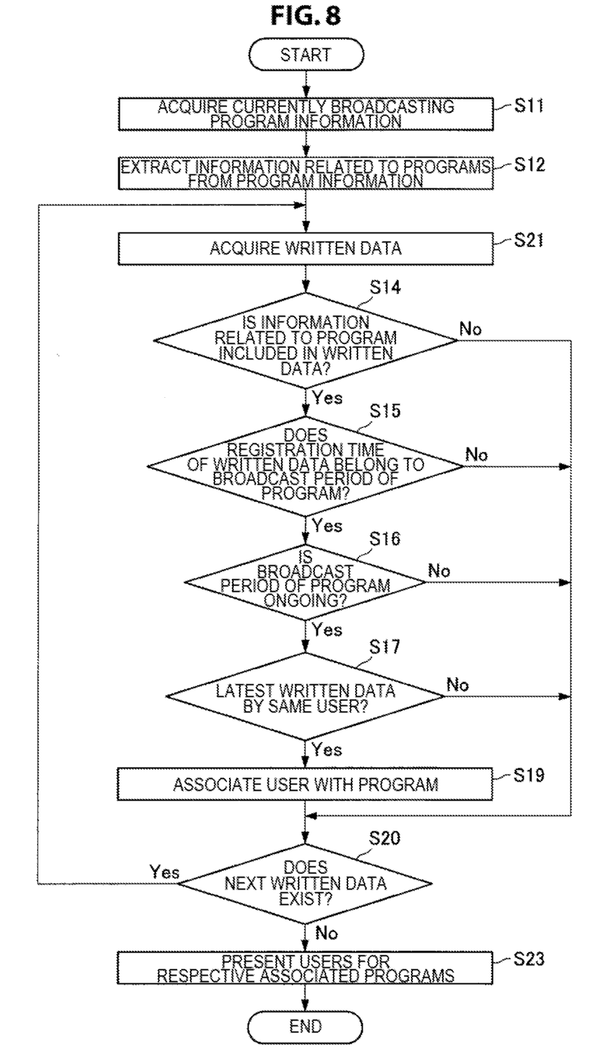

Next, an operation example of presenting the users who are viewing the programs for the respective programs, which is an example of the function of the information processing apparatus 10A according to the first embodiment of the present disclosure, will be described. FIG. 8 is a flowchart illustrating an operation example of presenting the users who are viewing the programs for the respective programs, which is an example of the function of the information processing apparatus 10A according to the first embodiment of the present disclosure. Note that the operation example illustrated in FIG. 8 is merely an example of operation for presenting users who are viewing programs for the respective programs. Thus, the operation for presenting the users who are viewing the programs for the respective programs is not limited to the operation example illustrated in FIG. 8.

First, the control unit 110A of the information processing apparatus 10A acquires the program information received by the communication unit 130 from the EPG server 30 via the network 50 (S11). Subsequently, the control unit 110A extracts information related to the broadcast of the programs from the acquired program information (S12). Subsequently, the data processing unit 113 acquires the written data received by the communication unit 130 from the data management server 40 via the network 50 (S 21).

Subsequently, the data determination unit 111 determines whether or not information related to the program is included in the written data (S14). At this time, if it is determined that the information related to the program is not included in the written data (“No” in S14), the control unit 110A proceeds to the operation of S20. On the other hand, if it is determined that the information related to the program is included in the written data (“Yes” in S14), the time determination unit 112 determines whether or not the registration time of the written data belongs to the broadcast period of the program (S15). At this time, if it is determined that the registration time of the written data does not belong to the broadcast period of the program (“No” in S15), the control unit 110A proceeds to the operation of S20.

Subsequently, the data processing unit 113 determines whether or not the program broadcasting is ongoing, with reference to the broadcast period of the program and current time (S16). If the data processing unit 113 determines that the program broadcasting is not ongoing (“No” in S16), the data processing unit 113 proceeds to the operation of S20. On the other hand, if the data processing unit 113 determines that the program broadcasting is ongoing (“Yes” in S16), the data processing unit 113 determines whether or not the written data is the latest written data by the same user (S17). Although such determination may be made in any way, this determination may be made by acquiring the written data in order from newer registration time and checking whether or not the acquired written data is the first written data by the same user, for example.

If the data processing unit 113 determines that the written data is not the latest written data by the same user (“No” in S17), the data processing unit 113 proceeds to the operation of S20. On the other hand, if the data processing unit 113 determines that the written data is the latest written data by the same user (“Yes” in S17), the data processing unit 113 proceeds to the operation of S22. Subsequently, when the operation proceeds to S22, the data processing unit 113 associates the user who has written the written data with the program (S22) and proceeds to the operation of S20.

When the operation has proceeded to S20, the control unit 110A determines whether or not the next written data exists (S20). If it is determined that the next written data exists (“Yes” in S20), the control unit 110A proceeds to the operation of S21. On the other hand, if it is determined that the next written data does not exist (“No” in S20), the control unit 110A presents the users (displays the user's names) for the respective associated programs (S23), and ends the operation.

In the above, the example of presenting the users who are viewing the programs for the respective programs, which is an example of the function of the information processing apparatus 10A according to the first embodiment of the present disclosure, has been described. Note that a case in which the data processing unit 113 presents the users who are viewing the programs, including the user who uses the information processing apparatus 10A, for the respective programs is illustrated in the above, but the users who are viewing the programs, excluding the user who uses the information processing apparatus 10A, may be presented for the respective programs.

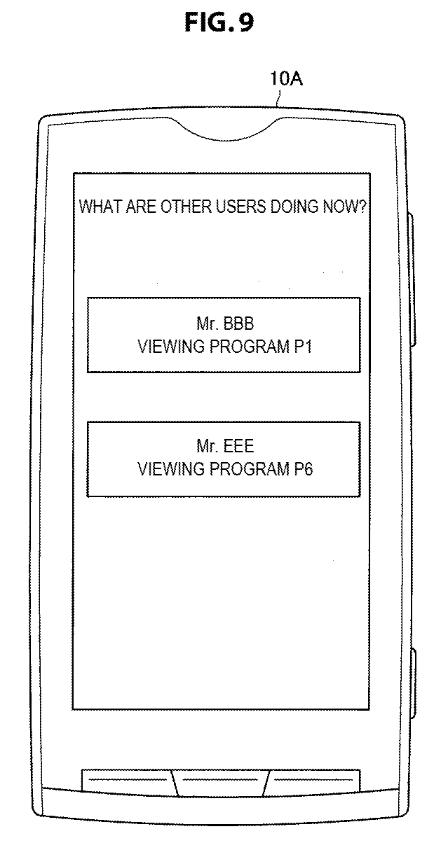

FIG. 9 is a diagram illustrating an example of a display screen image for presenting other users who are viewing programs for the respective programs. For example, as illustrated in FIG. 9, the data processing unit 113 of the information processing apparatus 10A may cause the display unit 150 to display the user BBB who is viewing the program P1. Also, the data processing unit 113 of the information processing apparatus 10A may cause the display unit 150 to display the user EEE who is viewing the program P6. However, when the user who uses the information processing apparatus 10A is the user AAA, the data processing unit 113 of the information processing apparatus 10A is needless to display the user AAA as a user who views the programs P6, even if the user AAA is viewing the program P6.

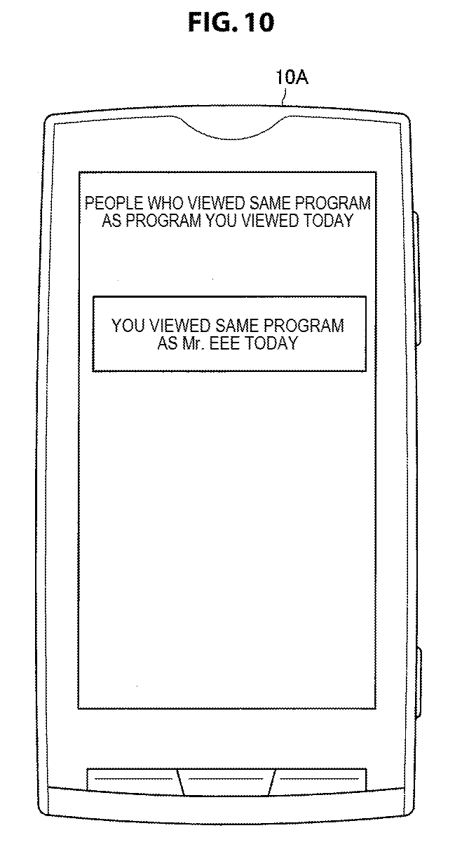

Although the example of presenting the users who are viewing the programs for the respective programs in real time has been described in the above, the users who viewed the programs (for example, the names of the users) may be presented for the respective programs with reference to a program view history. For example, the programs viewed by the user can be identified on the basis of selection operation of broadcast station input to the input unit 120, and be stored in the storage unit 140 as the program view history. According to this configuration, it is possible to understand the users who viewed the programs in the past on a program-by-program basis. FIG. 10 is a diagram illustrating an example of a display screen image for informing of other users who viewed the same program as one user on the basis of the view history.

For example, it is assumed that a fact that the user AAA and the user EEE both viewed the program P6 is stored in the storage unit 140 as the program view history. In that case, as illustrated in FIG. 10, the data processing unit 113 of the information processing apparatus 10A used by the user AAA may cause the display unit 150 to display the user EEE as the user who viewed the same program as the user AAA. According to this configuration, the user AAA who uses the information processing apparatus 10A can understand the fact that the user EEE also viewed the same program as the program that the user AAA viewed, and have a conversation with the user EEE about the same program.

The first embodiment of the present disclosure has been described above.

### 2. Second Embodiment

Next, a second embodiment of the present disclosure will be described. In the following description, of the components of the second embodiment of the present disclosure, the same components as components of the first embodiment of the present disclosure will be denoted with the same reference numerals as the reference numerals attached to the components of the first embodiment of the present disclosure. Also, in the following description, the description will be omitted with regard to the same components as the components of the first embodiment of the present disclosure, among the components of the second embodiment of the present disclosure.

In the second embodiment of the present disclosure, a case in which the above “predetermined incident” is “holding an event”, and the above “involvement in the predetermined incident by the user” is “participation in the event”, and the above “indication that the user is involved in the predetermined incident” is “indication that the user is participating in the event” will be described as an example. Also, in the second embodiment of the present disclosure, a case in which the above “related information of the predetermined incident” is “information related to the holding of the event” will be described as an example.

### 2.1. System Configuration Example

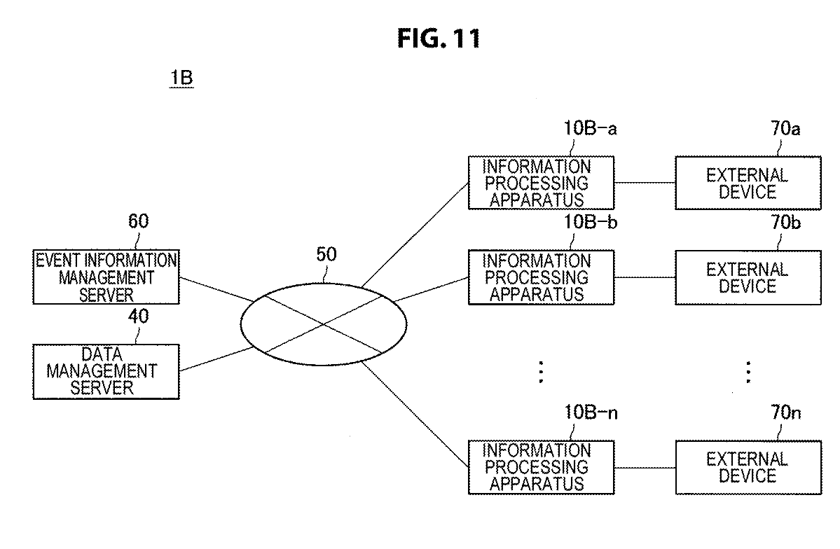

First, a configuration example of the information processing system 1B according to the second embodiment of the present disclosure will be described with reference to the drawings. FIG. 11 is a diagram illustrating a configuration example of the information processing system 1B according to the second embodiment of the present disclosure. As illustrated in FIG. 11, the information processing system 1B according to the second embodiment of the present disclosure includes information processing apparatuses 10B-a to 10B-n, external devices 70a to 70n, an event information management server 60, and a data management server 40. The information processing apparatuses 10B-a to 10B-n, the event information management server 60, and the data management server 40 are connected to a network 50. Also, the external devices 70a to 70n are connected to the information processing apparatuses 10B-a to 10B-n, respectively.

The event information management server 60 transmits information (hereinafter also referred to as “event information”) related to participation in various events to the information processing apparatuses 10B-a to 10B-n via the network 50. Although the specific structure of the event information is not limited particularly, the event information may include at least one of names of cast members of the event, an organizer name of the event, a venue name of the event, a name of the event, and detailed information of the event, for example. In the following, a case in which the event information includes all of the names of the cast members in the event, the organizer name of the event, the venue name of the event, the name of the event, and the detailed information of the event will be described as an example. Also, the event information management server 60 transmits an event holding period (event start time and end time) to the information processing apparatuses 10B-a to 10B-n via the network 50. Also, in the following, an example in which the event information supplied from the event information management server 60 is used will be described mainly, but event information extracted from the written data stored by the data management server 40 may be used.

The information processing apparatus 10B according to the second embodiment of the present disclosure is capable of receiving event information from the event information management server 60. The communication between the information processing apparatus 10B and the data management server 40 according to the second embodiment of the present disclosure can be performed in the same way as the communication between the information processing apparatus 10A and the data management server 40 according to the first embodiment of the present disclosure. The data management server 40 according to the second embodiment of the present disclosure also has the same function as the data management server 40 according to the first embodiment of the present disclosure.

The external device 20 activates a predetermined function (for example, a navigation function or the like) in accordance with an activation signal from the information processing apparatus 10B to be connected. The predetermined function activated by the information processing apparatus 10B will be described later. Although in the example illustrated in FIG. 11 the information processing system 1B includes the external devices 70a to 70n, the information processing system 1B is needless to include the external devices 70a to 70n when the information processing apparatuses 10B-a to 10B-n themselves have the predetermined function.

In the above, the configuration example of the information processing system 1B according to the second embodiment of the present disclosure has been described.

### 2.2. Functional Configuration Example

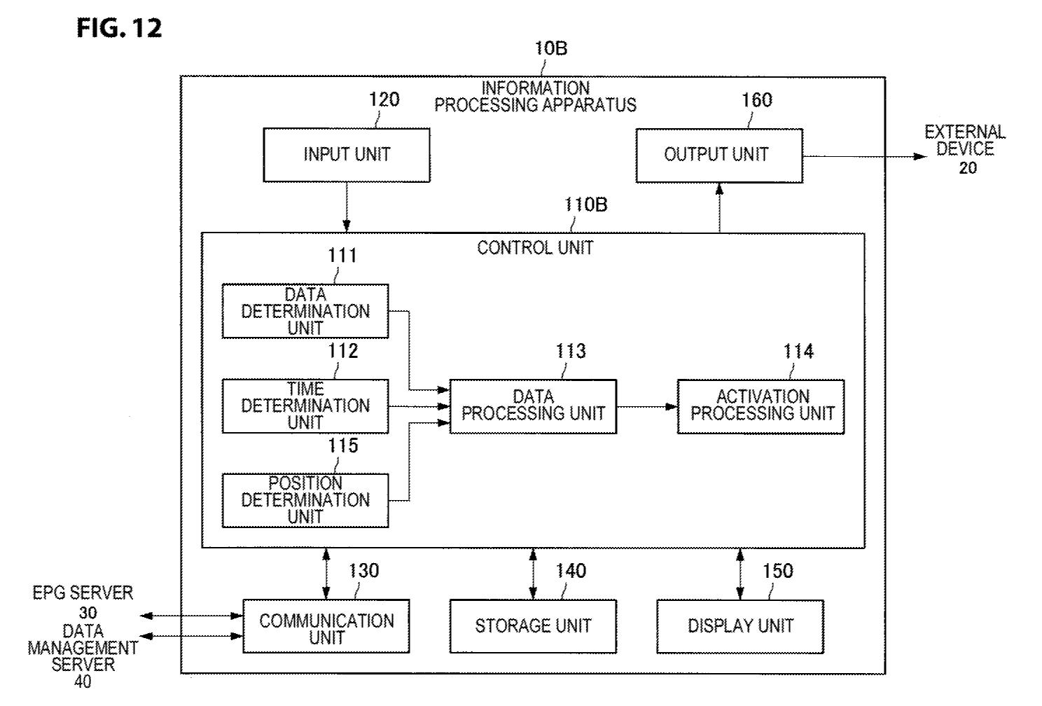

Next, a functional configuration example of the information processing apparatus 10B according to the second embodiment of the present disclosure will be described. FIG. 12 is a block diagram illustrating a functional configuration example of the information processing apparatus 10B according to the second embodiment of the present disclosure. As illustrated in FIG. 12, the information processing apparatus 10B according to the second embodiment of the present disclosure includes a control unit 110B, an input unit 120, a communication unit 130, a storage unit 140, a display unit 150, and an output unit 160.

The control unit 110B can be equivalent to a processor such as a CPU, for example. When the control unit 110B is equivalent to a processor such as a CPU, such a processor can be configured with an electronic circuit. The control unit 110B performs various functions of the control unit 110B, by executing a program stored in the storage unit 140 or other storage media. The control unit 110B includes a data determination unit 111, a time determination unit 112, a data processing unit 113, an activation processing unit 114, and a position determination unit 115. The function of the position determination unit 115 will be described later.

In the above, the functional configuration example of the information processing apparatus 10B according to the second embodiment of the present disclosure has been described.

### 2.3. Estimation of Users Who are Participating in Events

Next, an example of the function of the information processing apparatus 10B according to the second embodiment of the present disclosure will be described. As described above, the information processing apparatus 10B attempts to log in to the data management server 40 on the basis of the user identification information and the password input by the user. When login is completed and a request for viewing written data is input from the user, the communication unit 130 of the information processing apparatus 10B receives the written data from the data management server 40 via the network 50, and the data processing unit 113 causes the display unit 150 to display the written data received by the communication unit 130.

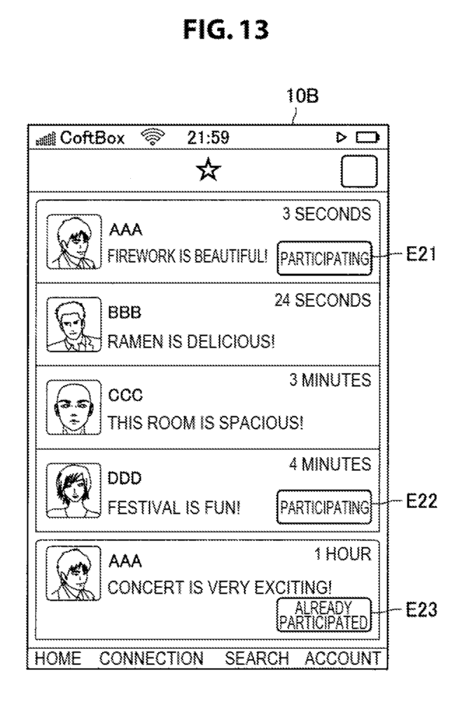

FIG. 13 is a diagram illustrating an example of a written data display screen image. FIG. 13 illustrates an example in which the data processing unit 113 of the information processing apparatus 10B causes the display unit 150 to display written data “firework is beautiful!” whose (user's name, difference period between current time and registration time) are (AAA, 3 seconds). In the same way, in the example illustrated in FIG. 13, the data processing unit 113 of the information processing apparatus 10B causes the display unit 150 to display written data “ramen is delicious!” whose (user's name, difference period between current time and registration time) are (BBB, 24 seconds).

Also, the data processing unit 113 of the information processing apparatus 10B causes the display unit 150 to display written data “this room is spacious!” whose (user's name, difference period between current time and registration time) are (CCC, 3 minutes). Also, the data processing unit 113 of the information processing apparatus 10B causes the display unit 150 to display written data “festival is fun!” whose (user's name, difference period between current time and registration time) are (DDD, 4 minutes). Further, the data processing unit 113 of the information processing apparatus 10B causes the display unit 150 to display written data “concert is very exciting!” whose (user's name, difference period between current time and registration time) are ((AAA, 1 hour).

Here, the data determination unit 111 determines whether or not event information is included in the written data by the user, and the time determination unit 112 determines whether or not the registration time of the written data belongs to the holding period of the event. When the event information is included in the written data and the registration time of the written data belongs to the holding period of the event, the data processing unit 113 estimates that the user is participating in the event and attaches an indication that the user is participating in the event to the written data.

For example, it is assumed that the data determination unit 111 has determined that the event name “firework” is included in the written data “firework is beautiful!” by the user AAA. Also, it is assumed that the time determination unit 112 has determined that the registration time of the written data “firework is beautiful!” belongs to the holding period of this event. In that case, the data processing unit 113 may attach a button E21 (hereinafter also simply referred to as “participating button E21”) in which a character string “participating” is written, to the written data “firework is beautiful!”.

In the same way, it is assumed that the data determination unit 111 has determined that the event name “festival” is included in the written data “festival is fun!” by the user DDD. Also, it is assumed that the time determination unit 112 has determined that the registration time of the written data “festival is fun!” belongs to the holding period of this event. In that case, as illustrated in FIG. 13, the data processing unit 113 may attach a button E22 (hereinafter also simply referred to as “participating button E22”) in which a character string “participating” is written, to the written data “festival is fun!”.

According to this configuration, both of the viewpoint as to whether or not the registration time of the written data is included in the holding period of the event and the viewpoint as to whether or not the written data includes the event information are used in determination of a participation state in the event. Therefore, it is possible to understand the situation of the user who has written the written data with higher accuracy. Instead of the participating buttons E21 and E22, some objects indicating participating in the event may be attached to the written data “firework is beautiful!” and “festival is fun!”.

Also, the data processing unit 113 may permanently attach the participating button E21 to the written data, but the data processing unit 113 may attach an indication that the user no longer participates in the event, to the written data, when a predetermined condition is satisfied. According to this configuration, it is possible to understand the situation of the user who has written the written data with higher accuracy, by further considering the possibility that the user no longer participates in the event.

For example, even if the participating button E21 is once attached to one written data, the data processing unit 113 may attach an indication that the user no longer participates in the event to the one written data, when there is another written data by the same user which includes information related to the holding of another event which is held after the holding of the event (another event in which the start of holding period is later than the end of the holding period of one event).

In the example illustrated in FIG. 13, the written data “concert is very exciting!” written by the user AAA includes the name of the event (concert). However, the written data “firework is beautiful!” written by the same user AAA includes another event name (firework) that is held after the holding of the event. Therefore, the data processing unit 113 may attach a button E23 (hereinafter also simply referred to as “already-participated button E23”) in which a character string “already participated” is written in the written data “concert is very exciting!”, to the written data “concert is very exciting!”.

According to this configuration, it is possible to understand the situation of the user who has written the written data with higher accuracy, by considering the possibility that the user no longer participates in the one event because the user starts participating in the other event. Note that, instead of the already-participated button E23, some object indicating no longer participating in the event may be attached to the written data “concert is very exciting!”.

Also, for example, even if the participating buttons E21 and E22 are once attached to one written data, the data processing unit 113 may attach an indication that the user no longer participates in the event, to the written data, when the current time no longer belongs to the holding period of the event that was being participated. According to this configuration, it is possible to understand the situation of the user who has written the written data with higher accuracy, by considering the possibility that the user can no longer participate in the event due to the end of the holding period of the event.

The participating buttons E21 and E22 displayed in this way may be selectable by the user who operates the information processing apparatus 10B. Then, when the user who operates the information processing apparatus 10B selects the participating buttons E21 and E22, the data processing unit 113 may cause the display unit 150 to display the detailed information of the event that is being participated.

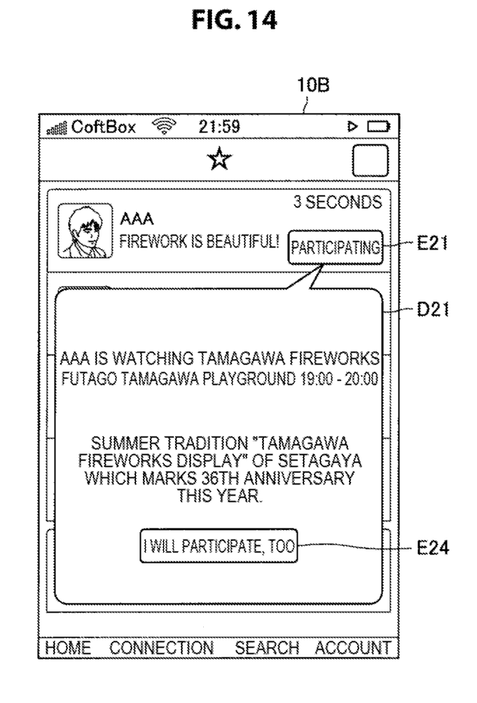

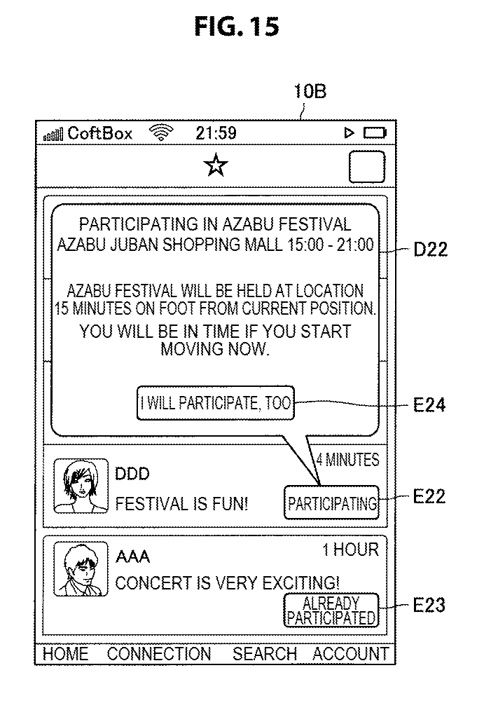

FIG. 14 and FIG. 15 are diagrams illustrating display examples of detailed information of events. FIG. 14 illustrates an example in which the data processing unit 113 displays detailed information D21 of the event that the user AAA is participating when the participating button E21 attached to the written data “firework is beautiful!” is selected by the user who operates the information processing apparatus 10B.

Note that the detailed information D21 includes “AAA is watching Tamagawa fireworks”, “Futago Tamagawa Playground”, and “19:00-20:00”, but the name of the event, the venue name of the event, and the holding period of the event can be acquired from the event information management server 60. Also, as illustrated in FIG. 14, the detailed information D21 may include “summer tradition ‘Tamagawa fireworks display’ of Setagaya which marks 36th anniversary this year” as an example of the outline of the event.

Also, the user of the information processing apparatus 10B may be allowed to participate in the event “firework” in which the user AAA is participating, by selecting an event participation button E24 (or the participating button E21) indicating the intention to participate in the event. That is, when the event participation button E24 (or the participating button E21) is selected by the user who operates the information processing apparatus 10B, the activation processing unit 114 may activate the navigation function for guiding the route to the event venue by the external device 20 connected to the information processing apparatus 10B. The external device 20 may display a guidance screen image generated by the activated navigation function.

Also, FIG. 15 illustrates an example in which the data processing unit 113 displays detailed information D22 of the event that the user DDD is participating in, when the participating button E22 attached to the written data “festival is fun!” is selected by the user who operates the information processing apparatus 10B. Note that the detailed information D22 includes “participating in Azabu festival”, “Azabu Juban Shopping Mall”, and “15:00-21:00”, but the name of the event, the venue name of the event, and the holding period of the event can be acquired from the event information management server 60.

Here, the position determination unit 115 may determine whether or not the user who uses the information processing apparatus 10B can participate in the event, on the basis of the position of the user who uses the information processing apparatus 10B, the venue position of the event, the current time, and the holding period of the event. Then, the data processing unit 113 may display information indicating whether or not the user who uses the information processing apparatus 10B can participate in the event. Although the position of the user who uses the information processing apparatus 10B may be measured in any way, the position may be measured by a global positioning system (GPS) function of the information processing apparatus 10B, for example. The venue position of the event can be acquired from the event information management server 60.

Although whether or not the user who uses the information processing apparatus 10B can participate in the event may be determined in any way, it may be determined depending on whether or not the arrival time at the event venue in relation to the current time, which is obtained by route search in which the starting point is the current position of the user who uses the information processing apparatus 10B and the end point is the event venue position, is before the start time (or the end time) of the event holding period. When it is determined that the user who uses the information processing apparatus 10B can participate in the event, the data processing unit 113 may display information for guiding the movement to the event venue from the current position of the user who uses the information processing apparatus 10B.

In the example illustrated in FIG. 15, since the position determination unit 115 has determined that the user who uses the information processing apparatus 10B can participate in the event, the detailed information D22 includes “Azabu festival will be held at location 15 minutes on foot from current position. You will be in time if you start moving now.”, as an example of the outline of the event. As in this example, the detailed information D22 may include the required time from the current position of the user who uses the information processing apparatus 10B to the event venue.

Alternatively, when it is determined that the user who uses the information processing apparatus 10B can participate in the event, the data processing unit 113 may cause the display unit 150 to display information for guiding the movement (for example, a traveling route or the like) from the current position of the user who uses the information processing apparatus 10B to the event venue. When the information for guiding the movement from the current position of the user who uses the information processing apparatus 10B to the event venue is displayed, the user who uses the information processing apparatus 10B can be assisted in moving to the event venue, for example.

Also, the user of the information processing apparatus 10B may be allowed to participate in the event “firework” in which the user AAA is participating in, by selecting the event participation button E24 (or the participating button E21) indicating the intention to participate in the event. That is, when the event participation button E24 (or the participating button E21) is selected by the user who operates the information processing apparatus 10B, the activation processing unit 114 may activate the navigation function for guiding the route to the event venue by the external device 20 connected to the information processing apparatus 10B. The external device 20 may display a guidance screen image generated by the activated navigation function.

In the above, an example in which the external device 20 has the navigation function activated by the activation processing unit 114 has been described, but the information processing apparatus 10B may have the navigation function activated by the activation processing unit 114. In that case, the guidance screen image generated by the navigation function of the information processing apparatus 10B may be displayed by the display unit 150 of the information processing apparatus 10B. Alternatively, stream of the guidance screen image received by the navigation function of the information processing apparatus 10B may be distributed from the information processing apparatus 10B to the external device 20, and the stream may be displayed by the external device 20.

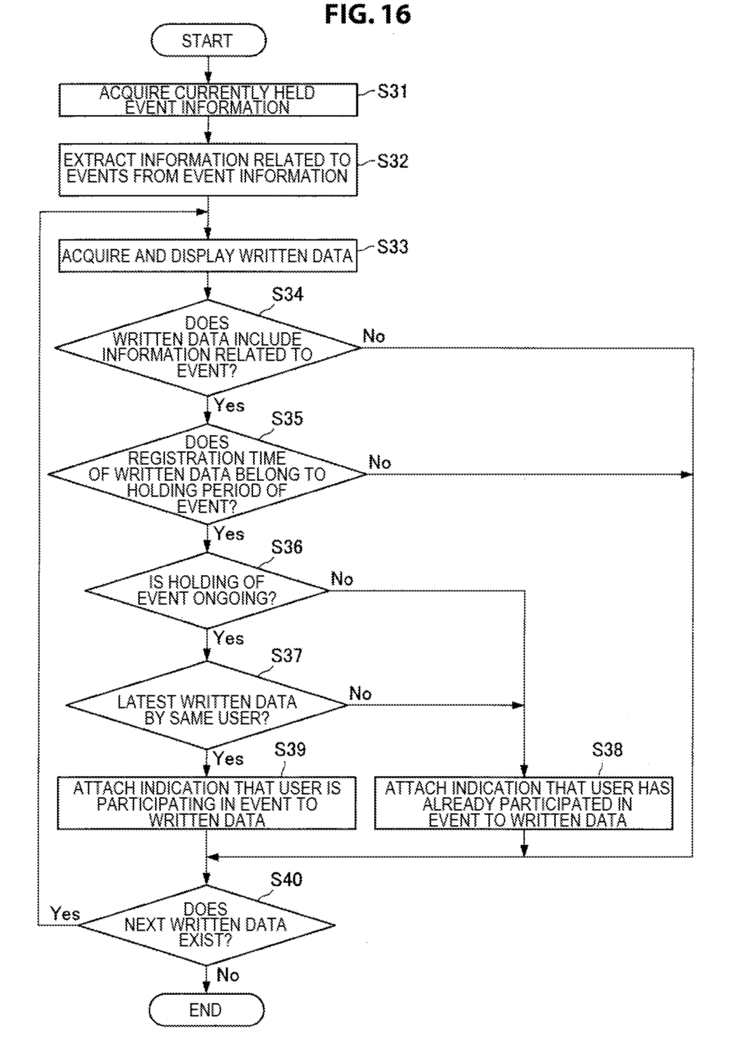

Next, an operation example of estimation of users who are participating in events, which is an example of the function of the information processing apparatus 10B according to the second embodiment of the present disclosure, will be described. FIG. 16 is a flowchart illustrating an operation example of estimation of users who are participating in events, which is an example of the function of the information processing apparatus 10B according to the second embodiment of the present disclosure. Note that the operation example illustrated in FIG. 16 is merely an example of the estimation operation of the users who are participating in the events. Therefore, the operation of estimation of the users who are participating in the events is not limited to the operation example illustrated in FIG. 16.

First, the control unit 110B of the information processing apparatus 10B acquires currently held event information received by the communication unit 130 from the event information management server 60 via the network 50 (S31). Subsequently, the control unit 110B extracts information related to the events from the acquired event information (S32). Subsequently, the data processing unit 113 acquires the written data received by the communication unit 130 from the data management server 40 via the network 50, and causes the display unit 150 to display the acquired written data (S33).

Subsequently, the data determination unit 111 determines whether or not information related to the event is included in the written data (S34). At this time, if it is determined that the information related to the event is not included in the written data (“No” in S34), the control unit 110B proceeds to the operation of S40. On the other hand, if it is determined that the information related to the event is included in the written data (“Yes” in S34), the time determination unit 112 determines whether or not the registration time of the written data belongs to the event holding period (S35). At this time, if it is determined that the registration time of the written data does not belong to the event holding period (“No” in S35), the control unit 110B proceeds to the operation of S40.

Subsequently, the data processing unit 113 determines whether or not the holding of the event is ongoing, with reference to the holding period of the event and the current time (S36). If it is determined that the holding of the event is not ongoing (“No” in S36), the data processing unit 113 proceeds to the operation of S38. On the other hand, if it is determined that the holding of the event is ongoing (“Yes” in S36), the data processing unit 113 determines whether or not the written data is the latest written data by the same user (S37). Although such determination may be made in any way, this determination may be made by acquiring the written data in order from newer registration time and checking whether or not the acquired written data is the first written data by the same user, for example.

If it is determined that the written data is not the latest written data by the same user (“No” in S37), the data processing unit 113 proceeds to the operation of S38. On the other hand, if it is determined that the written data is the latest written data by the same user (“Yes” in S37), the data processing unit 113 proceeds to the operation of S39. Subsequently, when the operation has proceeded to S38, the data processing unit 113 attaches an indication that the user has already participated in the event to the written data (S38), and proceeds to the operation of S40. On the other hand, when the operation has proceeded to S39, the data processing unit 113 attaches an indication that the user is participating in the event to the written data (S39), and proceeds to the operation of S40.

When the operation has proceeded to S40, the control unit 110B determines whether or not the next written data exists (S40). If it is determined that the next written data exists (“Yes” in S40), the control unit 110B proceeds to the operation of S33. On the other hand, if it is determined that the next written data does not exist (“No” in S40), the control unit 110B may end the operation.

In the above, the estimation of the users who are participating in the events, which is an example of the function of the information processing apparatus 10B according to the second embodiment of the present disclosure, has been described.

The position of the user may be considered in the estimation of the user who are participating in the event. That is, the position determination unit 115 may determine whether or not the venue position of the event is identical with or close to the user position at the time of registration of the written data. Then, when the written data includes the information related to the holding of the event, and the registration time of the written data belongs to the holding period of the event, and the venue position of the event is identical with or close to the user position at the time of registration of the written data, the data processing unit 113 may attach the indication that the user is participating in the event, to the written data.

According to this configuration, it is possible to understand the situation of the user who has written the written data with higher accuracy, by further considering the user position.

### 2.4. Example of Presenting Users Who are Participating in Events for Respective Events

Next, an example of presenting users who are participating in events for the respective events, which is an example of the function of the information processing apparatus 10B according to the second embodiment of the present disclosure, will be described. In the above, an example is described in which, when a user estimated to be participating in an event exists, an indication of being participating in the event is attached to the written data of the user. However, the method of how to present the user estimated to be participating in the event is not limited to the above. For example, the data processing unit 113 may present one or a plurality of users (for example, names of users) for the respective events being participated. According to this configuration, it is possible to understand the users who are participating on an event-by-event basis.

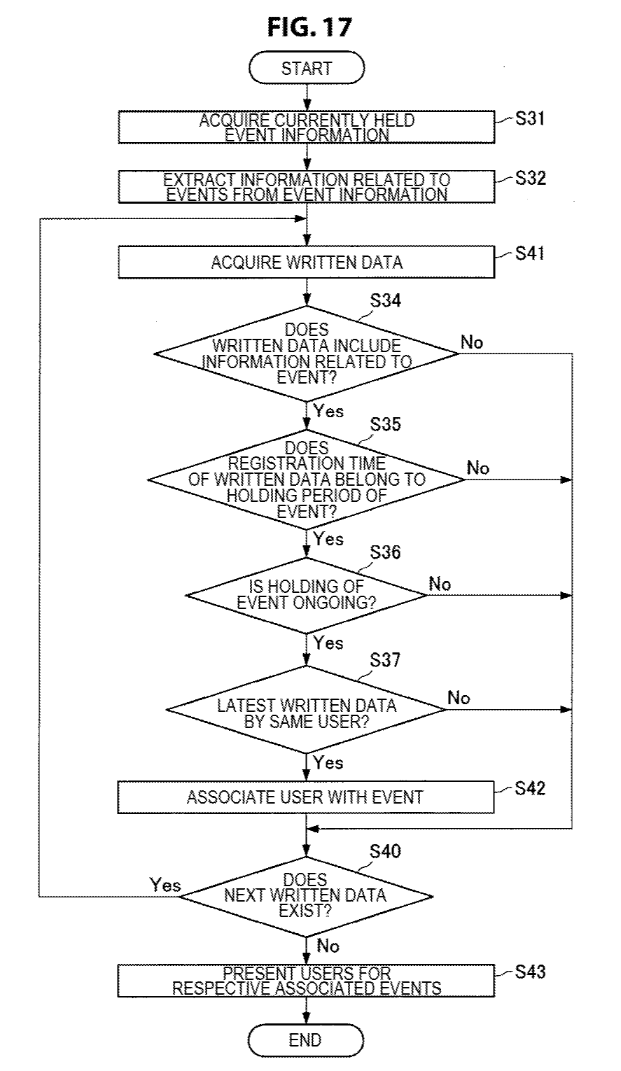

Next, an operation example for presenting users who are participating in events for the respective events, which is an example of the function of the information processing apparatus 10B according to the second embodiment of the present disclosure, will be described. FIG. 17 is a flowchart illustrating an operation example for presenting users who are participating in events for the respective events, which is an example of the function of the information processing apparatus 10B according to the second embodiment of the present disclosure. Note that the operation example illustrated in FIG. 17 is merely an operation example for presenting the users who are participating in the events for the respective events. Therefore, the operation for presenting the users who are participating in the events for the respective events is not limited to the operation example illustrated in FIG. 17.

First, the control unit 110B of the information processing apparatus 10B acquires currently held event information received by the communication unit 130 from the event information management server 60 via the network 50 (S31). Subsequently, the control unit 110B extracts information related to the events from the acquired event information (S32). Subsequently, the data processing unit 113 acquires the written data received by the communication unit 130 from the data management server 40 via the network 50 (S41).

Subsequently, the data determination unit 111 determines whether or not information related to the event is included in the written data (S34). At this time, if it is determined that the information related to the event is not included in the written data (“No” in S34), the control unit 110B proceeds to the operation of S40. On the other hand, if it is determined that the information related to the event is included in the written data (“Yes” in S34), the time determination unit 112 determines whether or not the registration time of the written data belongs to the event holding period (S35). At this time, if it is determined that the registration time of the written data does not belong to the event holding period (“No” in S35), the control unit 110B proceeds to the operation of S40.

Subsequently, the data processing unit 113 determines whether or not the holding of the event is ongoing, with reference to the holding period of the event and the current time (S36). If it is determined that the holding of the event is not ongoing (“No” in S36), the data processing unit 113 proceeds to the operation of S40. On the other hand, if it is determined that the holding of the event is ongoing (“Yes” in S36), the data processing unit 113 determines whether or not the written data is the latest written data by the same user (S37). Although such determination may be made in any way, this determination may be made by acquiring the written data in order from newer registration time and checking whether or not the acquired written data is the first written data by the same user, for example.

If it is determined that the written data is not the latest written data by the same user (“No” in S37), the data processing unit 113 proceeds to the operation of S40. On the other hand, if it is determined that the written data is the latest written data by the same user (“Yes” in S37), the data processing unit 113 proceeds to the operation of S42. Subsequently, when the operation has proceeded to S42, the data processing unit 113 associates the user who has written the written data with the event (S42), and proceeds to the operation of S40.

When the operation has proceeded to S40, the control unit 110B determines whether or not the next written data exists (S40). If it is determined that the next written data exists (“Yes” in S40), the control unit 110B proceeds to the operation of S41. On the other hand, if it is determined that the next written data does not exist (“No” in S40), the control unit 110B presents the users (displays the names of the users) for the respective associated events (S43), and may end the operation.

In the above, the estimation of the users who are participating in the events, which is an example of the function of the information processing apparatus 10B according to the second embodiment of the present disclosure, has been described. Note that in the above case the data processing unit 113 presents the users who are participating in the events, including the user who uses the information processing apparatus 10B, for the respective events, but the user who uses the information processing apparatus 10B may be excluded from the users who are participating in the events and are presented for the respective events.

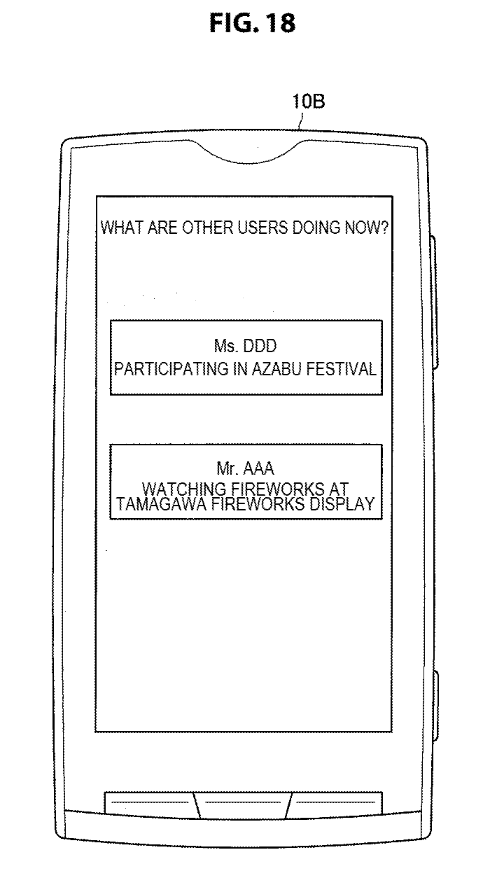

FIG. 18 is a diagram illustrating an example of a display screen image for presenting other users who are participating in the events for the respective events. For example, as illustrated in FIG. 18, the data processing unit 113 of the information processing apparatus 10B may cause the display unit 150 to display the user DDD who is participating in the festival. Also, the data processing unit 113 of the information processing apparatus 10B may cause the display unit 150 to display the user AAA who is participating in the firework. However, when the user who uses the information processing apparatus 10B is the user EEE, the data processing unit 113 of the information processing apparatus 10B is needless to display the user EEE as a user who participates in the firework, even if the user EEE participates in the firework.

In the above, an example in which the users who are participating in the events are presented in real time for the respective events has been described, but the users who participated in the events (for example, the names of the users) may be presented with reference to a past event participation history. According to this configuration, it is possible to understand the users who participated in the events in the past on an event-by-event basis.

In the above, the second embodiment of the present disclosure has been described.

### 3. Hardware Configuration Example

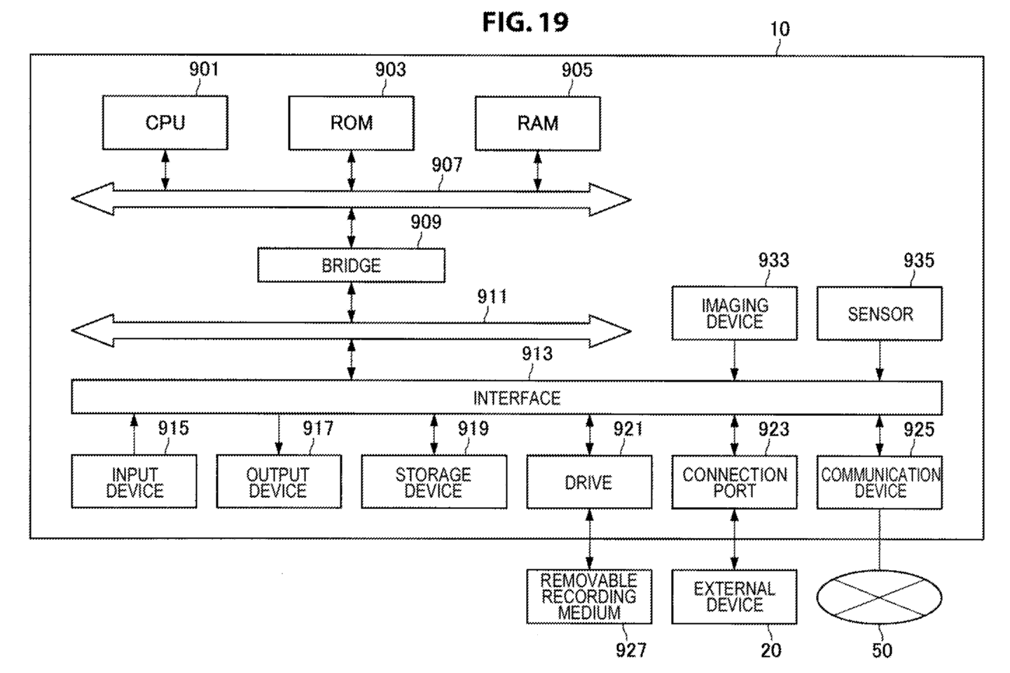

Next, a hardware configuration of the information processing apparatus 10 according to an embodiment of the present disclosure will be described with reference to FIG. 19. FIG. 19 is a block diagram illustrating a hardware configuration example of the information processing apparatus 10 according to the embodiment of the present disclosure.

As illustrated in FIG. 19, the information processing apparatus 10 includes a central processing unit (CPU) 901, a read only memory (ROM) 903, and a random access memory (RAM) 905. In addition, the information processing apparatus 10 may include a host bus 907, a bridge 909, an external bus 911, an interface 913, an input device 915, an output device 917, a storage device 919, a drive 921, a connection port 923, and a communication device 925. Further, the information processing apparatus 10 may include an imaging device 933 and a sensor 935 as necessary. The information processing apparatus 10 may include a processing circuit such as a digital signal processor (DSP) or application specific integrated circuit (ASIC), alternatively or in addition to the CPU 901.

The CPU 901 serves as an operation processor and a control device, and controls all or some operations within the information processing apparatus 10 in accordance with various programs recorded in the ROM 903, the RAM 905, the storage device 919 or a removable recording medium 927. The ROM 903 stores programs and operation parameters which are used by the CPU 901. The RAM 905 temporarily stores program which are used in the execution of the CPU 901 and parameters which are appropriately modified in the execution. The CPU 901, ROM 903, and RAM 905 are connected to each other by the host bus 907 configured to include an internal bus such as a CPU bus. In addition, the host bus 907 is connected to the external bus 911 such as a peripheral component interconnect/interface (PCI) bus via the bridge 909.

The input device 915 is a device which is operated by a user, such as a mouse, a keyboard, a touch panel, buttons, switches and a lever. The input device 915 may include a mic that detects a sound of a user. The input device 915 may be, for example, a remote control unit using infrared light or other radio waves, or may be an external connection device 929 such as a portable phone operable in response to the operation of the information processing apparatus 10. Furthermore, the input device 915 includes an input control circuit which generates an input signal on the basis of the information which is input by a user and outputs the input signal to the CPU 901. By operating the input device 915, a user can input various types of data to the information processing apparatus 10 or issue instructions for causing the information processing apparatus 10 to perform a processing operation. Moreover, an imaging device 933, which will be described later, images a motion of the hand of the user, the finger of the user, or the like, thereby functioning as an input device. At this time, a pointing position may be determined depending on the motion of the hand or the direction of the finger.

The output device 917 includes a device capable of visually or audibly notifying the user of acquired information. The output device 917 may include a display device such as a liquid crystal display (LCD), a plasma display panel (PDP), an organic electro-luminescence (EL) displays, and a projector, a hologram display device, an audio output device such as, a speaker or a headphone, and a peripheral device such as a printer. The output device 917 may output the results obtained from the process of the information processing apparatus 10 in a form of a video such as text or an image, and an audio such as voice or sound. The output device 917 may include a light or the like to brighten surroundings.

The storage device 919 is a device for data storage which is configured as an example of a storage unit of the information processing apparatus 10. The storage device 919 includes, for example, a magnetic storage device such as a hard disk drive (HDD), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 10 or attached externally thereto. The drive 921 reads information recorded in the removable recording medium 927 attached thereto, and outputs the read information to the RAM 905. Further, the drive 921 writes a record in the removable recording medium 927 attached thereto.

The connection port 923 is a port used to directly connect devices to the information processing apparatus 10. The connection port 923 may include a universal serial bus (USB) port, an IEEE1394 port, and a small computer system interface (SCSI) port. The connection port 923 may further include an RS-232C port, an optical audio terminal, a high-definition multimedia interface (HDMI) port, and so on. The connection of the external connection device 929 to the connection port 923 makes it possible to exchange various data between the information processing apparatus 10 and the external connection device 929.

The communication device 925 is, for example, a communication interface including a communication device or the like for connection to a communication network 931. The communication device 925 may be, for example, a communication card for a wired or wireless local area network (LAN), Bluetooth (registered trademark), wireless USB (WUSB) or the like. In addition, the communication device 925 may be a router for optical communication, a router for asymmetric digital subscriber line (ADSL), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device that generates an image by imaging a real space using an image sensor such as a charge-coupled device (CCD) or a complementary metal-oxide-semiconductor (CMOS) sensor, as well as various members such as one or more lenses for controlling the formation of a subject image on the image sensor, for example. The imaging device 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the information processing apparatus 10, such as the orientation of the case of the information processing apparatus 10, as well as information regarding the environment surrounding the information processing apparatus 10, such as the brightness or noise surrounding the information processing apparatus 10, for example. The sensor 935 may also include a global positioning system (GPS) sensor that receives GPS signals and measures the latitude, longitude, and altitude of the apparatus.

The foregoing thus illustrates an exemplary hardware configuration of the information processing apparatus 10. Each of the above components may be realized using general-purpose members, but may also be realized in hardware specialized in the function of each component. Such a configuration may also be modified as appropriate according to the technological level at the time of the implementation.

### 4. Conclusion

As described above, according to the embodiments of the present disclosure, there is provided the information processing apparatus 10 including: the data determination unit 111 that determines whether or not the related information of a predetermined incident is included in the written data by the user; the time determination unit 112 that determines whether or not the registration time of the written data belongs to a predetermined duration period including the period during which the predetermined incident is occurring; and the data processing unit 113 that attaches the indication that the user is involved in the predetermined incident to the written data when the written data includes the related information of the predetermined incident and the registration time of the written data belongs to the duration period. According to this configuration, it is possible to understand the situation of the user who has written the written data with higher accuracy.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the data processing unit 113 may calculate the number of users who are involved in each incident, and display the calculation result for each incident. According to this configuration, it is possible to calculate the degree of popularity of an incident with higher accuracy in consideration of the situations of the users.

More specifically, in the first embodiment of the present disclosure, the data processing unit 113 may calculate the number of users who are currently viewing the programs (or viewed the programs in the past) for the respective programs, and cause the display unit 150 to display the calculation result for the respective programs. Also, in the second embodiment of the present disclosure, the data processing unit 113 may calculate the number of users who are currently participating in the events (or participated in the events in the past) for the respective events, and cause the display unit 150 to display the calculation result for the respective events.

Also, in the above, an example in which the program information acquired from the EPG server 30, the event information acquired from the event information management server 60, and the like are used in their unchanged forms has been described. However, these information may have not only the acquired forms but also other forms after the acquired formats have been converted. For example, the name of the cast member acquired from the EPG server 30 may include not only the acquired name of the cast member but also another name (for example, a nickname or the like) after the acquired name of the cast member is converted.

Moreover, it is possible to create a program for allowing hardware such as a CPU, a ROM, or a RAM included in the computer to exhibit a function equal to the function of the information processing apparatus 10. Further, it is possible to provide a computer-readable recording medium that records the program.

Further, a program for realizing the information processing apparatus 10 may be a web application. In this case, the display control information may be realized by a markup language such as a hypertext markup language (HTML), a standard generalized markup language (SGML), or an extensible markup language (XML).

Note that, when the above-mentioned operation of the information processing apparatus 10 is realized, the position of each component is not limited in particular. As a specific example, the control unit 110, the input unit 120, and the display unit 150 may be arranged at different devices that are connected via a network. In this case, the control unit 110 may correspond to a server such as a web server or a cloud server, and the input unit 120 and the display unit 150 may correspond to clients connected to the server via a network. Also, each functional block of the control unit 110 may be provided in a distributed manner in a plurality of devices.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing apparatus including:

a data determination unit configured to determine whether or not related information of a predetermined incident is included in written data by a user;

a time determination unit configured to determine whether or not a registration time of the written data belongs to a predetermined duration period including a period during which the predetermined incident is occurring; and

a data processing unit configured to attach an indication that the user is involved in the predetermined incident to the written data, when the related information of the predetermined incident is included in the written data and the registration time of the written data belongs to the duration period.

(2)

The information processing apparatus according to c(1), wherein

the duration period includes a period from a start time of the predetermined incident or a predetermined time before the start time of the predetermined incident to an end time of the predetermined incident or a predetermined time after the end time of the predetermined incident.

(3)

The information processing apparatus according to (1), wherein

the data processing unit attaches an indication that the user is no longer involved in the predetermined incident to the written data when a predetermined condition is satisfied,

(4)

The information processing apparatus according to (3), wherein

the data processing unit attaches the indication that the user is no longer involved in the predetermined incident in the duration period to the written data, when a current time does not belong to the duration period.

(5)

The information processing apparatus according to (3), wherein

the data processing unit attaches the indication that the user is no longer involved in the incident to the written data, when there is written data by the user including related information of another incident that occurs after the predetermined incident.

(6)

The information processing apparatus according to any one of (1) to (5), wherein

the data processing unit presents one or a plurality of users for respective incidents that the one or a plurality of users are currently involved in.

(7)

The information processing apparatus according to any one of (1) to (5), wherein

the data processing unit presents one or a plurality of users for respective incidents that the one or a plurality of users have been involved in in the past.

(8)

The information processing apparatus according to any one of (1) to (7), wherein

the data processing unit calculates the number of users who are involved in respective incidents and causes calculation results to be displayed for the respective incidents.

(9)

The information processing apparatus according to (1), wherein

the predetermined incident is broadcasting of content,

the involvement of the user in the predetermined incident is viewing of the content, and

the indication that the user is involved in the predetermined incident is an indication that the user is viewing the content.

(10)

The information processing apparatus according to (9), wherein

the data processing unit causes detailed information of the content to be displayed, when the indication that the user is viewing the content is selected by the user.

(11)

The information processing apparatus according to (9), including

an activation processing unit configured to activate a reception function of the content, when the indication that the user is viewing the content is selected.

(12)

The information processing apparatus according to any one of (9) to (11), wherein

the related information of the predetermined incident is information related to the broadcasting of the content, and includes at least one of a name of a cast member of the content, a name of a broadcast station that broadcasts the content, a name of the content, a hashtag of the broadcast station that broadcasts the content, a hashtag of the content, and detailed information of the content.

(13)

The information processing apparatus according to (1), wherein

the predetermined incident is holding of an event,

the involvement of the user in the predetermined incident is participation in the event, and

the indication that the user is involved in the predetermined incident is an indication that the user is participating in the event.

(14)

The information processing apparatus according to (13), wherein

the data processing unit causes detailed information of the event to be displayed, when the indication that the user is participating in the event is selected.

(15)

The information processing apparatus according to (13), including

an activation processing unit configured to activate a navigation function for guiding the user to a route to a venue of the event, when the indication that the user is participating in the event is selected.

(16)

The information processing apparatus according to any one of (13) to (15), including

a position determination unit configured to determine whether or not a venue position of the event is identical with or close to a user position at a time of registration of the written data,

wherein the data processing unit attaches the indication that the user is participating in the event to the written data, when the written data includes information related to the holding of the event, and the registration time of the written data belongs to the duration period, and the venue position of the event is identical with or close to the user position at the time of the registration of the written data.

(17)

The information processing apparatus according to (16), wherein

the position determination unit determines whether or not another user is able to participate in the event, on the basis of a position of the other user, the venue position of the event, a current time, and a holding period of the event, and

the data processing unit causes information indicating whether or not the other user is able to participate in the event to be displayed,

(18)

The information processing apparatus according to (17), wherein

when it is determined that the other user is able to participate in the event, the data processing unit causes information for guiding movement from a current position of the other user to a venue to be displayed.

(19)

The information processing apparatus according to any one of (13) to (18), wherein

the related information of the predetermined incident is information related to the holding of the event, and includes at least one of a name of a cast member of the event, an organizer name of the event, a venue name of the event, a name of the event, and detailed information of the event.

(20)

An information processing method including:

determining whether or not related information of a predetermined incident is included in written data by a user;

determining whether or not a registration time of the written data belongs to a predetermined duration period including a period during which the predetermined incident is occurring; and

attaching an indication that the user is involved in the predetermined incident to the written data, when the related information of the predetermined incident is included in the written data and the registration time of the written data belongs to the duration period.

### REFERENCE SIGNS LIST

1 (1A, 1B) information processing system
10 (10A, 10B) information processing apparatus
20 (20a to 20n) external device
30 EPG server
40 data management server
50 network
60 event information management server
70a to 70n external device
110 (110A, 110B) control unit
111 data determination unit
112 time determination unit
113 data processing unit
114 activation processing unit
115 position determination unit
120 input unit
130 communication unit
140 storage unit
150 display unit
160 output unit

1. An information processing apparatus comprising:
a data determination unit configured to determine whether or not related information of a predetermined incident is included in written data by a user;
a time determination unit configured to determine whether or not a registration time of the written data belongs to a predetermined duration period including a period during which the predetermined incident is occurring; and
a data processing unit configured to attach an indication that the user is involved in the predetermined incident to the written data, when the related information of the predetermined incident is included in the written data and the registration time of the written data belongs to the duration period.

2. The information processing apparatus according to claim 1, wherein
the duration period includes a period from a start time of the predetermined incident or a predetermined time before the start time of the predetermined incident to an end time of the predetermined incident or a predetermined time after the end time of the predetermined incident.

3. The information processing apparatus according to claim 1, wherein
the data processing unit attaches an indication that the user is no longer involved in the predetermined incident to the written data when a predetermined condition is satisfied,

4. The information processing apparatus according to claim 3, wherein
the data processing unit attaches the indication that the user is no longer involved in the predetermined incident in the duration period to the written data, when a current time does not belong to the duration period.

5. The information processing apparatus according to claim 3, wherein
the data processing unit attaches the indication that the user is no longer involved in the incident to the written data, when there is written data by the user including related information of another incident that occurs after the predetermined incident.

6. The information processing apparatus according to claim 1, wherein
the data processing unit presents one or a plurality of users for respective incidents that the one or a plurality of users are currently involved in.

7. The information processing apparatus according to claim 1, wherein
the data processing unit presents one or a plurality of users for respective incidents that the one or a plurality of users have been involved in in the past.

8. The information processing apparatus according to claim 1, wherein
the data processing unit calculates the number of users who are involved in respective incidents and causes calculation results to be displayed for the respective incidents.

9. The information processing apparatus according to claim 1, wherein
the predetermined incident is broadcasting of content,
the involvement of the user in the predetermined incident is viewing of the content, and
the indication that the user is involved in the predetermined incident is an indication that the user is viewing the content.

10. The information processing apparatus according to claim 9, wherein
the data processing unit causes detailed information of the content to be displayed, when the indication that the user is viewing the content is selected by the user.

11. The information processing apparatus according to claim 9, comprising
an activation processing unit configured to activate a reception function of the content, when the indication that the user is viewing the content is selected.

12. The information processing apparatus according to claim 9, wherein
the related information of the predetermined incident is information related to the broadcasting of the content, and includes at least one of a name of a cast member of the content, a name of a broadcast station that broadcasts the content, a name of the content, a hashtag of the broadcast station that broadcasts the content, a hashtag of the content, and detailed information of the content.

13. The information processing apparatus according to claim 1, wherein
the predetermined incident is holding of an event,
the involvement of the user in the predetermined incident is participation in the event, and
the indication that the user is involved in the predetermined incident is an indication that the user is participating in the event.

14. The information processing apparatus according to claim 13, wherein
the data processing unit causes detailed information of the event to be displayed, when the indication that the user is participating in the event is selected.

15. The information processing apparatus according to claim 13, comprising
an activation processing unit configured to activate a navigation function for guiding the user to a route to a venue of the event, when the indication that the user is participating in the event is selected.

16. The information processing apparatus according to claim 13, comprising
a position determination unit configured to determine whether or not a venue position of the event is identical with or close to a user position at a time of registration of the written data,
wherein the data processing unit attaches the indication that the user is participating in the event to the written data, when the written data includes information related to the holding of the event, and the registration time of the written data belongs to the duration period, and the venue position of the event is identical with or close to the user position at the time of the registration of the written data.

17. The information processing apparatus according to claim 16, wherein
the position determination unit determines whether or not another user is able to participate in the event, on the basis of a position of the other user, the venue position of the event, a current time, and a holding period of the event, and
the data processing unit causes information indicating whether or not the other user is able to participate in the event to be displayed,

18. The information processing apparatus according to claim 17, wherein
when it is determined that the other user is able to participate in the event, the data processing unit causes information for guiding movement from a current position of the other user to a venue to be displayed.

19. The information processing apparatus according to claim 13, wherein
the related information of the predetermined incident is information related to the holding of the event, and includes at least one of a name of a cast member of the event, an organizer name of the event, a venue name of the event, a name of the event, and detailed information of the event.

20. An information processing method comprising:
determining whether or not related information of a predetermined incident is included in written data by a user;
determining whether or not a registration time of the written data belongs to a predetermined duration period including a period during which the predetermined incident is occurring; and
attaching an indication that the user is involved in the predetermined incident to the written data, when the related information of the predetermined incident is included in the written data and the registration time of the written data belongs to the duration period.
